(19) United States
(12) Patent Application Publication
(10) Pub. No.: US 2025/0063121 A1
(43) Pub. Date: Feb. 20, 2025

(54) SECURE MULTI-TENANT PROTOCOL-AGNOSTIC VOICE CALL RECORDING

(71) Applicant: NICE LTD., Ra'anana (IL)

(72) Inventors: Yaron COHEN, Modiin (IL); Shay Shem Tov LEVY, Raanana (IL); Roni KRIVOSHEY, Ramat Hasharon (IL)

(73) Assignee: NICE LTD., Ra'anana (IL)

(21) Appl. No.: 18/625,773

(22) Filed: Apr. 3, 2024

Related U.S. Application Data
(60) Provisional application No. 63/532,961, filed on Aug. 16, 2023.

(51) Int. Cl. H04M 7/00; H04L 65/1095

(52) U.S. Cl. CPC H04M 7/0006; H04L 65/1095; H04M 7/006

(57) ABSTRACT

Embodiments are disclosed for securing internet-based transfer of voice call data. Embodiments may include: sending a primary-protocol-encoded communication, by a forwarding unit (FU), to a session border controller (SBC), when an indication is received at the FU that a secondary-protocol-encoded communication has been received at a gateway component, from a voice call data source, to propose transferring voice call data to the SBC; outputting by the SBC, in response to the primary-protocol-encoded communication an IP address encoded with the primary protocol; converting, by a gateway component, the IP address encoded with the primary protocol into an IP address encoded with the secondary protocol; and sending, by a gateway component, the IP address encoded with the secondary protocol to the voice call data source that is proposing to transfer the voice call data.

### PRIOR APPLICATION DATA

The present application claims the benefit of prior U.S. provisional application 63/532,961, filed on Aug. 16, 2023, which is incorporated by reference herein in its entirety.

### FIELD OF THE INVENTION

The present invention relates generally to the provision of protocol-agnostic systems and methods for carrying out secure multi-tenant voice call recording, wherein voice calls are carried out by third parties and transferred via a public network.

### BACKGROUND OF THE INVENTION

It may be desired to provide services for remote or third-party recording of voice calls (or similar interactions), that may take place at a facility such as a contact center. A server for recording voice calls may be configured to receive data indicative of voice calls from a number of sources over a public network, such as the internet. It may be necessary to ensure that connection between the server and the sources is secure using one or more known security devices, such as a session border controller.

Sources may attempt to communicate to the server using any number of different voice over IP (VOIP) protocols, however session border controllers are ordinarily programmed to operate using only one or only a small number of standard VoIP protocols. It may, therefore, be desirable to provide embodiments for secure third-party recording of voice calls that are protocol-agnostic or adaptable to be operable with non-standard VoIP protocols.

### SUMMARY OF THE INVENTION

Embodiments may improve third-party voice call recording technology by providing systems and methods (e.g., unified methods) that are capable of secure, protocol-agnostic, third-party (or contact center) recording of voice calls. Embodiments disclosed herein may leverage existing security devices, such as session border controllers (SBCs), which are configured to operate using a primary protocol, such that they may be used as security devices for contact centers configured to use secondary protocols.

Embodiments are disclosed for securing internet-based transfer of voice call data. Embodiments may include: sending a primary-protocol-encoded communication, by a forwarding unit (FU), to a session border controller (SBC), when an indication is received or upon receiving the indication at the FU that a communication has been received at a connectivity component, from a voice call data source, to propose transferring voice call data to the SBC, wherein the FU is communicatively coupled to the SBC and to the connectivity component, wherein the primary-protocol-encoded communication comprises a request to establish a source-agnostic connection to the SBC, wherein the SBC is configured to use communications encoded with the primary protocol and the connectivity component is configured to communicate with the voice call data source; outputting by the SBC, in response to the primary-protocol-encoded communication an IP address encoded with the primary protocol, wherein the IP address indicative of a location configured to receive the voice call data; converting, by a gateway component, the IP address encoded with the primary protocol into an IP address encoded with the secondary protocol, wherein the gateway component is configured to communicate with the voice call data source using a secondary protocol; and/or sending, by the gateway component, the IP address encoded with the secondary protocol to the voice call data source that is proposing to transfer the voice call data.

Embodiments are disclosed for internet-based transfer of telephony data. Embodiments may include: transmitting a communication encoded by a first protocol, by a forwarding unit (FU), to a server security component, upon an indication being received at the FU that a communication has been received at a server connection, from a telephony data source, to transfer telephony data to the server security component, wherein the FU is in communication with the server security component and the server connection, wherein the communication encoded by a first protocol comprises a request to establish a source-agnostic connection to the server security component, wherein the server security component is configured to use communications encoded with the first protocol and the server connection is configured to communicate with the telephony data source; outputting by the server security component an IP address encoded with the first protocol, wherein the IP address is of a location to receive the telephony data; converting, by a gateway component, the IP address encoded with the first protocol into an IP address encoded with the secondary protocol; and/or sending, by the gateway component, the IP address encoded with the secondary protocol to the telephony data source.

### BRIEF DESCRIPTION OF THE DRAWINGS

The subject matter regarded as the invention is particularly pointed out and distinctly claimed in the concluding portion of the specification. The invention, however, both as to organization and methods of operation, together with objects, features, and advantages thereof, may best be understood by reference to the following detailed description when read with the accompanying drawings in which:

FIG. 1 shows a network diagram of an existing system including a server for recording voice calls from one or more sources.

FIG. 2 shows a network diagram of an existing system including a server for recording voice calls from one or more sources.

FIG. 3 shows a network diagram of a multi-tenant recording system according to embodiments of the invention.

FIG. 4 shows a network diagram of a multi-tenant recording system according to embodiments of the invention.

FIG. 5 shows a dataflow diagram of embodiments for securing internet-based transfer of voice call data, according to some embodiments of the present invention.

FIG. 6 shows a graphical representation of the modification of data passing through a gateway according to some embodiments of the present invention.

FIG. 7 shows a flowchart diagram of embodiments for securing internet-based transfer of voice call data according to some embodiments of the present invention.

FIG. 8 shows a block diagram of an exemplary computing device which may be used with embodiments of the present invention.

### DETAILED DESCRIPTION OF THE INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

As used herein, “contact center”, “tenant”, “third party”, “on premise customer”, “(voice call/telephony) data source”, or “source” may refer to an office or company (e.g., a centralized office) used for receiving or transmitting a large volume of contacts, enquiries, communications, interactions, or calls. The contacts, enquiries, communications, interactions, or calls may use voice calls, telephony data, emails, message chats, SMS (short message service) messages, etc. A contact center may, for example, be operated by a company to administer incoming product or service support or information enquiries from customers/consumers. The company may be a contact-center-as-a-service (CCaaS) company. A contact center may use an automatic call distributor (ACD) system for routing contacts or calls to agents. As used herein, “call center” may refer to a contact center that primarily handles voice calls rather than other types of enquiries, communications, or interactions. Any reference to a contact center herein should be taken to be applicable to a call center, and vice versa. A tenant may be an organization which shares resources with other organizations within a larger data center or cloud computing facility: a data center or cloud computing facility may use its computing and storage resources to service multiple tenants.

As used herein, “interaction”, “contact”, “call”, “voice call”, or “voice-based interaction” may refer to a communication between two or more people (e.g., in the context of a contact center, an agent and a customer), typically via devices such as computers, customer devices, agent devices, etc., and may include, for example, voice telephone calls, conference calls, video recordings, face-to-face interactions (e.g., as recorded by a microphone or video camera), etc. An interaction may be recorded to generate one or more data files such as an “interaction recording” or “call recording”, transcripts, metadata, etc. An interaction, or interaction recording/call recording, may also refer to data which is transferred and stored in a computer system recording the interaction and may represent an interaction, including for example the streams of data exchanged during the interaction, voice or video recordings created after the interaction, data items describing the interaction or the parties, a text-based transcript of the interaction, etc. Interactions as described herein may be “computer-based interactions”, e.g., one or more voice telephone calls, conference calls, video recordings/streams of an interaction, face-to-face interactions (or recordings thereof), etc. Interactions may be computer-based if, for example, the interaction has associated data or metadata items stored or processed on a computer, the interaction is tracked or facilitated by a server, the interaction is recorded on a computer, data is extracted from the interaction, etc. Some computer-based interactions may take place via the internet, such as conference calls, whereas some computer-based interactions may take place via other networks, such as some telephone calls. Interactions may be converted into text-based interaction recordings (e.g., using automatic speech recognition).

As used herein, “session border controller” “SBC”, or “server security component” may refer to a network or server component for establishing network connections to external entities (e.g., data sources), providing security for the network or server, resource allocation (e.g., regulating bandwidth and traffic), and/or other functions. SBCs may be configured to operate using one or more protocols. For example, a data source may attempt to establish a session with an SBC using a communication encoded with Session Initiation Protocol (SIP), and the SBC may be configured to understand or operate based on a SIP encoded communication. In some embodiments, there may be protocols in which a communication may be encoded, which the SBC is not able to understand or operate based on. For example, an SBC may not be able to understand proprietary protocols, such as Avaya Device, Media and Call Control (DMCC) protocols. SBCs may provide one or more of the following functionalities: a firewall, a proxy, multi-tenant support, support for mono and stereo sound, failover support, support for various telephony codecs, support for auto-scaling media or media decomposition, and script customization such as for adding tenant identification to SIP requests. SBCs may not be easy to modify to understand new protocols. SBCs may be called different names, and thus, when used herein, “session border controller” or “SBC” may refer to network or server components (e.g., for security) not explicitly named “session border controllers” or “SBCs”, but which are recognized to perform the same or substantially the same set of functions as an SBC. SBCs may act as back-to-back user agents (B2BUAs), for example, according to some embodiments herein, between a forwarding unit and a gateway component.

As used herein, “forwarding unit” “enhanced forwarding unit” or “FU” may refer to a unit for, among other functions, supporting media-forking and supporting multiple media requesters. FUs may be equipped with a load balancer. FUs may include selective forwarding units (SFUs) and/or enhanced selective forwarding units (E-SFUs). FUs may support mono and stereo interactions, and/or be highly available and/or highly resilient. FUs may support intelligent media-forking, multiple interaction media requesters (e.g. audio recorders, real-time monitoring, real-time authentication, real-time interaction guidance (RTIG), etc.), and may be “Non-functional-High Available, High Resilient”, handling session failover.

Protocols as referred to herein may include various protocols as may be known in the art. Protocols herein may be described as “primary”, “secondary”, and/or “tertiary” protocols. Protocols may include voice over IP (VOIP) protocols, for example, Session Initiation Protocol (SIP); Session Recording Protocol (SIPREC); H.323; Media Gateway Control Protocol (MGCP); H.248; Real-time Transport Protocol (RTP); Secure Real-time Transport Protocol (SRTP); Avaya Device, Media and Call Control (DMCC); Cisco Skinny Client Control Protocol (SCCP); Alcatel DR link; or others as may be known in the art. In embodiments herein, primary protocols may include VoIP protocols that are understood by a session border controller (SBC) of a server, or which the SBC may operate with. In embodiments herein secondary protocols may, for example, in embodiments where voice call data sources do not use the primary protocol, include VoIP protocols that are used by a voice call data source. In embodiments herein, secondary protocols may include VoIP protocols that are not understood by a session border controller (SBC) of a server, or which the SBC may not operate with. Protocols may additionally include computer telephony and integration (CTI) protocols, for example, Computer-supported telecommunications applications (CSTA); Java Telephony API (JTAPI); Telephony Server Application Programming Interface (TSAPI); or others as may be known in the art. In embodiments herein, tertiary protocols may include CTI protocols.

The primary protocol herein may, in many embodiments, include session initiation protocol (SIP). SIP may offer firewall security, support for multiple tenants, dynamic allocation of ports (or IP addresses), virtual private cloud (VPC) termination, and/or Real-Time Transport Control Protocol functionality for audio quality. The secondary protocol herein may, in many embodiments, include proprietary protocols (e.g., not open standards), such as Avaya Device, Media and Call Control (DMCC); Cisco Skinny Client Control Protocol (SCCP); and Alcatel DR link. Other primary and/or secondary protocols may be used.

As used herein, “connectivity component” or “connectivity pack” may be a component, as may be known in the art, for establishing or managing connections over a public network, such as the internet. Connectivity components may be configured to operate using CTI protocols (or a tertiary protocol as referred to herein). Connectivity components may use standard ACD, PBX, dialers and other telephony related components or SDK tools to integrate with telephony components to receive CTI related (e.g. interactions related) events.

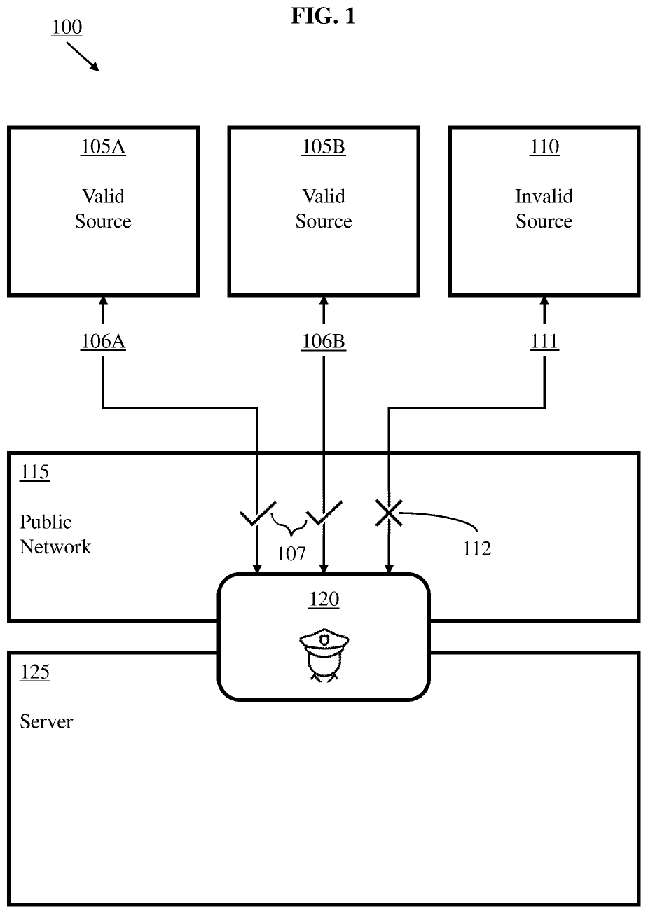

FIG. 1 shows a network diagram of an existing system 100 including a server 125 for recording voice calls from one or more sources 105A, 105B, 110. The sources may be or be associated with contact centers. FIG. 1 illustrates a role of a session border controller. A session border controller (SBC) 120 of the server may be configured to communicate with the sources, and/or the sources may be configured to communicate with the SBC, using a public network 115, such as the internet. The server, public network/internet, and sources/customers may be referred to as “domains”, e.g., server domain, internet domain, and customer domain. FIG. 1 shows an example in which each source communicates using a protocol that the SBC understands, however, one source is not permitted to establish a session. Sources may include “valid sources” 105A, 105B. Valid sources may, for example, be any sources that have permission to record voice calls using the server. Voice call data, and/or other data, such as requests for recording voice calls, IP addresses for sending or transmitting voice call data to, or other data (e.g., as referred to herein) may be sent between the valid sources and the SBC, via one or more data connections 106A, 106B. The SBC may be configured to ascertain whether the sources should be allowed to establish a session or connection with the server. In the case of the valid sources, this may be decided in the affirmative, for example, as indicated with ticks 107. The SBC may, in the case of valid sources, provide means for the valid sources to access the server, for example, by providing an IP address for sending one or more voice calls to, and/or encryption keys (e.g., public encryption keys) for encrypting or securing voice call data during transit. The SBC may ensure that there is no interference when multiple valid sources attempt to use the same resources or IP addresses, e.g., by securely providing unique IP addresses to each valid source. Sources may also include “invalid sources” 110. Invalid sources may include any sources that do not have permission to record voice calls using the server, and may additionally include malicious entities, e.g., network components comprising malware. An invalid source may, for example, attempt to establish session or connection with the server via data connection 111, however the SBC may ascertain and decide (e.g., by confirming that an invalid source is not on a provided list, e.g., a whitelist, of valid sources, or is on a provided list, e.g., a blacklist, of invalid sources) that the source should not be allowed to establish a session or connection with the server, for example, as indicated by cross 112. FIG. 1 may thus illustrate the advantages of using security devices such as SBCs, for example, the ability to block invalid sources from accessing a server, and stopping valid sources from interfering with the operations of other valid sources. The server herein may be or include a virtual private cloud (VPC).

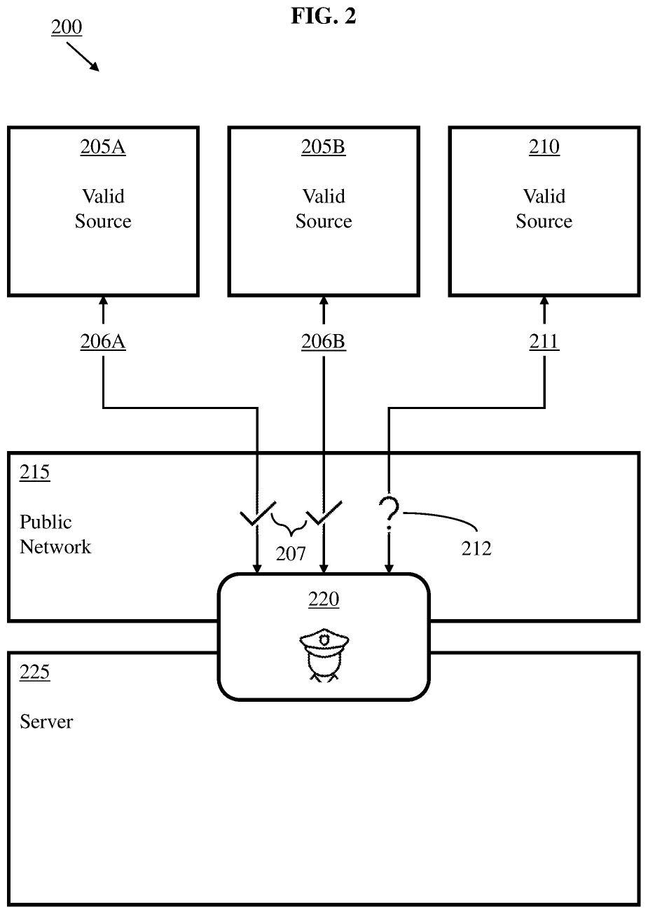

FIG. 2 shows a network diagram of an existing system 200 including a server 225 for recording voice calls from one or more sources 205A, 205B, 210. FIG. 2 illustrates a shortcoming of some existing systems. A session border controller (SBC) 220 of the server may be configured to communicate with the sources, and/or the sources may be configured to communicate with the SBC, using a public network 215, such as the internet. FIG. 2 shows an example, wherein the system 200 is much the same as system 100 of FIG. 1, but under different circumstances, wherein each source is permitted to establish a session, however, one source is not communicating using a protocol (e.g., VoIP protocol) that the SBC understands. Sources may be “valid sources” 205A, 205B, 210 in that they have permission to record voice calls using the server. Voice call data, and/or other data, such as requests for recording voice calls, IP addresses for sending voice call data to, or other data (e.g., as referred to herein) may be sent between the sources and the SBC, via one or more data connections 206A, 206B, 211. Some sources 205A, 205B may send communications, such as requests, via their respective data connections 206A, 206B, using or encoded in a primary protocol that the SBC understands. As such, a session or connection with the server may be established, for example, as indicated with ticks 207. Some sources 210 may send communications, such as requests, via their respective data connections 211, using a secondary protocol that the SBC does not understand. As such, a session or connection with the server may, in some embodiments, not be established. However, this may not be desirable, as the source is permitted to establish a session or connection. This undesirable situation may, for example, be indicated with question mark 212. SBCs may not easily be modifiable to understand new protocols, such as the secondary protocol referred to herein.

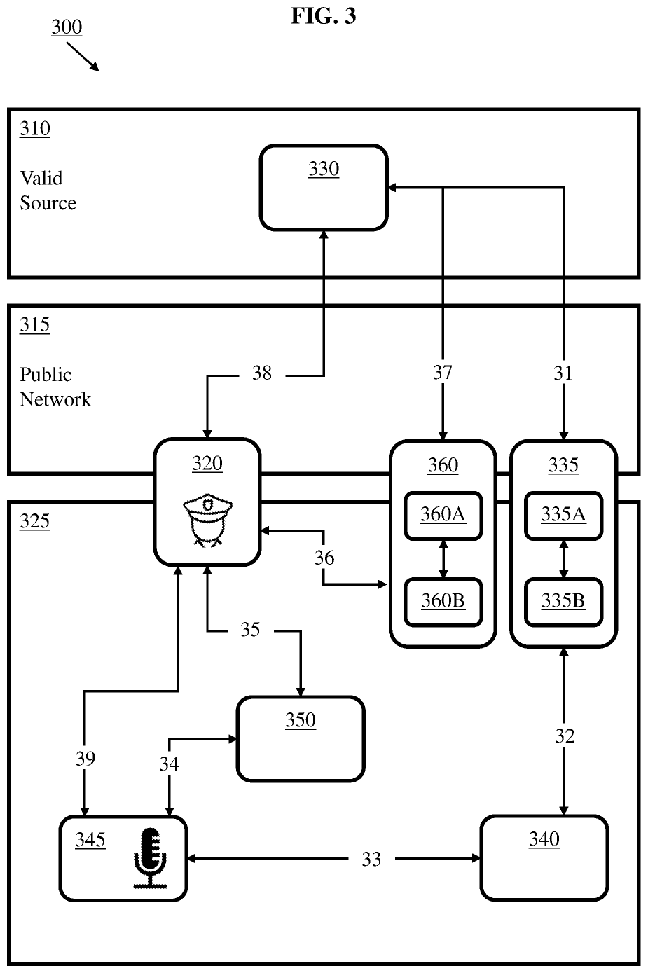

FIG. 3 shows a network diagram of a multi-tenant recording system 300 according to embodiments of the invention. As with systems described in FIGS. 1 and 2, the system may comprise a server 325 for recording voice calls from one or more sources. Communication between the one or more sources and the server is configured to take place using a public network 315, such as the internet. The server has a session border controller (SBC) 320 configured to operate with or understand a primary protocol (e.g. communications encoded in a primary protocol), for example, SIP. The depicted source 310 of FIG. 3 is, in this example, permitted to record voice calls using the server and may be configured to communicate (e.g., over public network 315) using a secondary protocol, for example, the Avaya DMCC protocol. The SBC may not be configured to understand or operate using the secondary protocol. Data connections as referred to herein may allow components to be communicatively coupled together.

It will be understood that at least some embodiments of the present invention may be intended to explicitly include only those components and operations carried out by the server 325, and not, for example, those carried out by the source 310 or public network 315.

The source may have an interface 330 configured to handle one or more external communications for the source. The server may have a gateway component 360 and/or connectivity component/pack 335. Each of the connectivity component and gateway component may be configured to communicate with sources, and may include an application programming interface (API). Each of the connectivity component and gateway component may lack a number of functionalities which the SBC is able to perform, however the gateway component may understand or be able to operate using the secondary protocol in use by a source, and/or a tertiary protocol. Each of the connectivity component and gateway component may support functionalities such as, for example: support for metadata from different sources which may be correlated together; interaction state management; support for multiple ACDs for a same tenant; support for various telephony features, such as complex calls, shared lines, and extension mobility; and support for agent login.

The connectivity component 335 may include a number of sub-components or parts. The connectivity component may include an application programming interface (API) interface or link 335A for communicating with a source, for example during establishing or managing connections, and associated components 335B, such as a driver. A driver may maintain a standard real-time graph of an interaction, regardless to the integrated ACD type and based on the PBX CTI events. The link 335A may be configured to operate using a tertiary protocol, such as CTI protocols.

The gateway component 360 may include a secondary-protocol interface or link 360A, for sending or transmitting an IP address encoded with the secondary protocol to a source or source interface, and associated components 360B, such as components for converting an IP address encoded with a primary protocol into an IP address encoded with a secondary protocol.

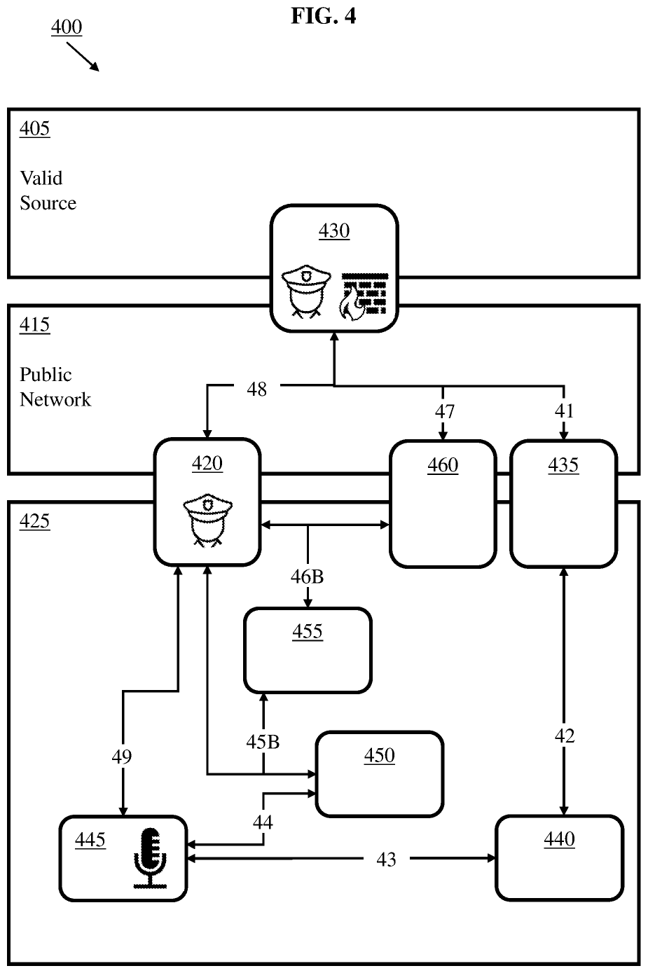

While FIG. 3 (and FIG. 4) shows the connectivity component and gateway component as being separate, their functions may be achieved, in some embodiments, by a same component.

The source interface 330 may send or transmit an indication to the connectivity component 335, using a data connection 31 (e.g., over a public network, such as the internet), that the source intends to transfer voice call data to the server. The indication may be encoded with may be encoded with a tertiary protocol (or secondary protocol), wherein the tertiary protocol may be any protocol used for establishing or managing connections (e.g., any protocol that is not the secondary protocol), for example, CTI protocols. In other words, the invention is not limited to a specific protocol used for the indication that the source intends to transfer voice call data to the server.

The connectivity component 335 may send or transmit to a recording controller 340, using a data connection 32, an indication that a source intends to transfer voice call data to the server.

The recording controller 340 may send or transmit to a recorder or recorder service 345, using a data connection 33, an indication that a source intends to transfer voice call data to the server.

The recorder 345 may send or transmit to a forwarding unit (FU) 350, using a data connection 34, an indication that a source intends to transfer voice call data to the server. In some embodiments, the FU may be a selective forwarding unit (SFU), and/or an enhanced selective forwarding unit (E-SFU).

The path taken by the indication that a source intends to transfer voice call data to the server may conform to the existence of physical data connections in servers 325, which may already exist.

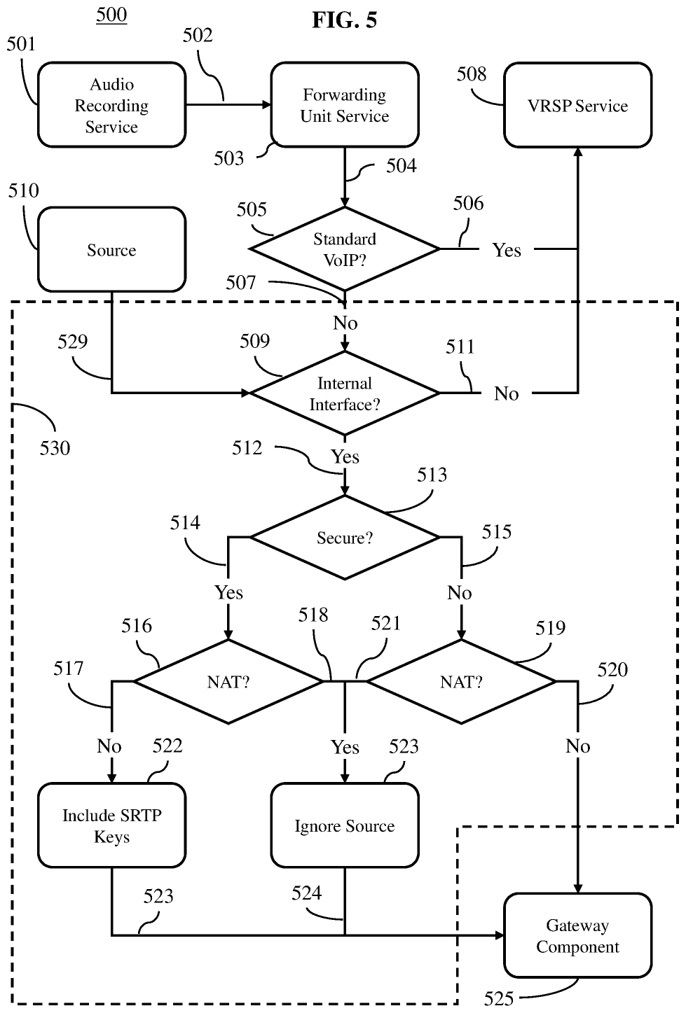

The FU 350 may, in response to or upon the receipt of the received indication that a source intends to transfer voice call data to the server, send or transmit to the server's session border controller (SBC) 320, using a data connection 35, a communication requesting to establish a source-agnostic connection to the SBC. The communication requesting to establish a source-agnostic connection to the SBC may be referred to as a forwarding request. The communication requesting to establish a source-agnostic connection to the SBC may be encoded with the primary protocol (e.g., that may be understood by the SBC). In other words, the communication may be a primary-protocol-encoded communication. The primary-protocol-encoded communication may, for example, be sent or transmitted to an internal or server-side interface of the SBC. Communications requesting to establish connections to an SBC may be source-agnostic if the requests are sent to an internal or server-side interface of the SBC. The SBC may be configured to be less strict with regards to security for communications received at an internal or server-side interface than communications received at an external or network-side interface (e.g., as may be observed from FIG. 5).

The SBC 320 may, in response to the received primary-protocol-encoded communication requesting to establish a source-agnostic connection to the SBC, output an IP address encoded with the primary protocol, and/or encryption keys (e.g., public encryption keys) for encrypting or securing voice call data during transit encoded with the primary protocol. The SBC may send or transmit the IP address encoded with the primary protocol to the gateway component 360 (directly or indirectly), using a data connection 36. The IP address may indicate a location configured to receive voice call data, for example, the voice call data that the source intends to transfer to the server. The SBC may additionally output other information related to establishing a connection to a source, for example, secure real-time transport protocol (SRTP) keys for encrypting voice call data during transmission.

The gateway component 360 may, in response to the received IP address encoded with the primary protocol (e.g., SIP), convert the IP address encoded with the primary protocol into an IP address encoded with the secondary protocol (e.g., Avaya DMCC) (e.g., using component 360B), and/or send or transmit the IP address encoded with the secondary protocol to the source 310 or source interface 330 (e.g., the source that is proposing to transfer the voice call data) (e.g., using component 360A), using a data connection 37 (e.g., over a public network, such as the internet).

The source 310 or source interface 330 may, in response to the IP address encoded with the secondary protocol, send voice call data to the IP address indicated by the SBC 320, using a data connection 38 (e.g., over a public network, such as the internet).

The received voice call data may be sent, transferred, or forwarded, using a data connection 39, to the recorder 345. The recorder may be configured to record or store the voice call data.

Various data connections as utilized herein, for example server data connections 33, 34, 35, and 39, may be data connections that are already present in existing apparatuses, such as servers for voice call recording.

FIG. 4 shows a network diagram of a multi-tenant recording system 400 according to embodiments of the invention. As with other descriptions herein, the example system may comprise a server 425 for recording voice calls from one or more sources. Communication between the one or more sources and the server is configured to take place using a public network 415, such as the internet. The server may include session border controller (SBC) 420 configured to operate with or understand a primary protocol, for example, SIP. The depicted source 405 of FIG. 4 is, in this example, permitted to record voice calls using the server and may be configured to communicate (e.g., over public network 415) using the primary protocol, e.g., as understood by the SBC. Data connections as referred to herein may allow components to be communicatively coupled together.

In the following, it will be understood that at least some embodiments of the present invention may be intended to explicitly include only those components and operations carried out by the server 425, and not, for example, those carried out by the source 410 or public network 415.

Components of FIG. 4 may, unless described otherwise be similar to or the same as corresponding components of FIG. 3.

The source may have an interface 430 configured to handle one or more external communications for the source, which may include a source session border controller (SBC) and/or a firewall. The server may have a gateway component 460 and/or connectivity component/pack 435, e.g., as discussed with respect to FIG. 3.

The connectivity component 435 may be communicatively coupled to or in communication with a recording controller 440, via a data connection 42.

The recording controller 440 may be communicatively coupled to or in communication with a recorder or recorder service 445, via a data connection 43.

The recorder 445 may be communicatively coupled to or in communication with a forwarding unit (FU) 450, via a data connection 44.

The FU 450 may, in some embodiments, be communicatively coupled to or in communication with a voice recording proxy (VRSP) 455 for the primary protocol, via a data connection 45B. A prior art VoIP flow may use a VRSP, as opposed to embodiments of the invention which may not require a VSRP.

A voice recording proxy (VRSP) 455 may, in some embodiments, be a component that is only used when primary-protocol-encoded communications are received from a source. The voice recording proxy may be referred to as a voice recording SIP proxy. The VRSP may be present in system 300 or FIG. 3, but since it might not be used for secondary-protocol-encoded communications from the source, it is not depicted therein. The VRSP may be highly available and/or highly resilient. The VRSP may be used as a correlation service between an FU and the SBC.

The SBC may, in some embodiments, be communicatively coupled to the VRSP 455, via a data connection 46B.

The source 405 or source interface 430 may send an indication to the SBC 420, using a data connection 48 (e.g., over a public network, such as the internet), that the source intends to transfer voice call data to the server. The indication may additionally or alternatively be sent to the gateway component 460 using data connection 41. The indication may be encoded with the primary protocol or a tertiary protocol (e.g., CTI protocols).

The gateway component 460 may be communicatively coupled to or in communication with the source interface 430, via a data connection 47.

The SBC 420 may, in response to the received primary-protocol-encoded communication requesting to establish a connection to the SBC, output an IP address encoded with the primary protocol. The SBC may send or transmit the IP address encoded with the primary protocol to the source 405 or source interface 430, using the data connection 48. The IP address may indicate a location (e.g., a port) configured to receive voice call data, for example, the voice call data that the source intends to transfer to the server.

The source 405 or source interface 430 may, in response to the IP address encoded with the primary protocol, send voice call data to the IP address indicated by the SBC 420, using the data connection 48 (e.g., over a public network, such as the internet). The source 405 or source interface 430 may generate encryption keys for encrypting or securing voice call data during transit.

The received voice call data may be sent, transferred, or forwarded, using a data connection 49, to the recorder 445. The recorder may be configured to record or store the voice call data.

FIG. 5 shows a dataflow diagram of embodiments 500 for securing internet-based transfer of voice call data, according to some embodiments of the present invention.

Element 501 may be an audio recording service or recorder. The audio recording service or recorder may be as described with respect to components 345 and 445 of FIGS. 3 and 4, respectively.

An indication that a source intends to transfer voice call data to the server may be sent or transmitted 502 from the audio recording service 501 to a forwarding unit service, or forwarding unit (FU) 503.

Element 503 may be a forwarding unit service or forwarding unit (FU). The FU may be as described with respect to components 350 and 450 of FIGS. 3 and 4, respectively.

A media forwarding request (or a communication requesting to establish a source-agnostic connection to the SBC) may move 504 from the FU to operation 505. The media forwarding request may be encoded in a primary protocol or standard protocol (e.g., SIP).

In operation 505 it may be assessed or ascertained whether the forwarding request relates to a source intending to transfer voice call data using a standard protocol (or primary protocol) or not (e.g., the source uses a secondary protocol, such as Avaya DMCC).

If the forwarding request does relate to a source intending to transfer voice call data using a standard protocol 506, the forwarding request may be sent or transferred to the VRSP service or VRSP. The VRSP may be as described with respect to component 455 of FIG. 4.

If the forwarding request does not relate to a source intending to transfer voice call data using a standard protocol 507 (e.g., a first protocol, or SIP), but rather, for example, using a non-standard protocol (e.g., Avaya DMCC), the forwarding request may be sent or transferred to operation 509 of the session border controller 530.

Elements and operations within the dashed line 530 may comprise part of a session border controller (SBC). The SBC may be as described with respect to components 320 and 420 of FIGS. 3 and 4, respectively.

Additionally or alternatively, the forwarding request may be sent or transferred 529 to operation 509 of the session border controller 530 by a voice call source 510.

In operation 509, it may be assessed or ascertained whether the forwarding request has been received at an internal interface of the SBC (e.g., as opposed to an external interface open to the public network or internet).

If the forwarding request has not been received at the internal interface (e.g., it has been received from the external interface) 511, the forwarding request may be sent or transferred to the VRSP service or VRSP.

If the forwarding request has been received at the internal interface 512, the forwarding request may move to operation 513.

In operation 513, it may be assessed whether the forwarding request relates to a source intending to transfer voice call data in a secure manner, for example, an encrypted transfer.

If the forwarding request does relate to a source intending to transfer voice call data in a secure manner 514, the forwarding request may move to operation 516, whereas, if the forwarding request does not relate to a source intending to transfer voice call data in a secure manner 515, the forwarding request may move to operation 519.

In each of operations 516 and 519, it may be assessed whether the forwarding request relates to a source intending to transfer voice call data using network address translation (NAT).

If, in operation 516, the forwarding request does not relate to a source intending to transfer voice call data using NAT 517, the forwarding request may move to operation 522.

If, in operation 519, the forwarding request does not relate to a source intending to transfer voice call data using NAT 520, the forwarding request and/or other information, such as an IP address may be sent or transferred to a gateway component 525. In so doing, the SBC may establish the possibility of a connection and may, for example, assign an IP address for receiving voice call data. The connection may not be source agnostic, and secure real-time transport protocol (SRTP) keys may not be included/provided.

If, in each of operations 516 and 519, the forwarding request does relate to a source intending to transfer voice call data using NAT 518, 521, the forwarding request may move to operation 523.

In operation 522, the SBC may establish the possibility of a connection and may, for example, assign an IP address for receiving voice call data. The connection may not be source agnostic, but secure real-time transport protocol (SRTP) keys may be included/provided.

In operation 523, the SBC may establish the possibility of a connection and may, for example, assign an IP address for receiving voice call data. The connection may be source agnostic. As such, a source-agnostic connection has been allowed, as required, so that a source may transfer voice call data using a non-standard protocol.

The forwarding request and/or other information, such as an IP address may be sent or transferred to a gateway component 525.

In some embodiments herein, it may be required in some circumstances that a source intends to transfer voice call data using NAT, however, this may be subject to requirements specific to a particular SBC.

Non-standard forward requests (e.g., relating to a secondary protocol) may, for example, take one of the following paths through the flowchart: 502, 504, 507, 512, 514, 518, 524, or 502, 504, 507, 512, 515, 521, 524.

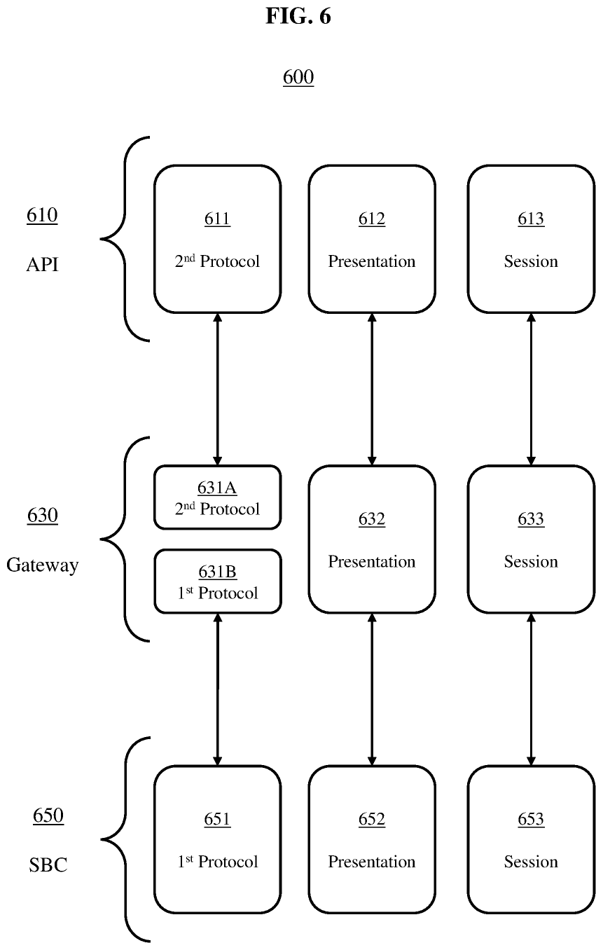

FIG. 6 shows a graphical representation of the modification of data passing through a gateway according to some embodiments of the present invention. FIG. 6 depicts a relation of a gateway component to primary and secondary protocols.

FIG. 6 includes a server interface, such as an API 610, a gateway component 630, and a session border controller (SBC) 650. Each of data indicative of a presentation or a session may move between the API 612, 613, the gateway 632, 633, and the SBC 652, 653, without conversion at the gateway. However, any data encoded in a primary (or 1^{st}) protocol 651 at the SBC, and data encoded in a secondary (or 2^{nd}) protocol 611 at the API may require conversion at the gateway component 631A, 631B in order that it is suitable for the API and SBC, respectively.

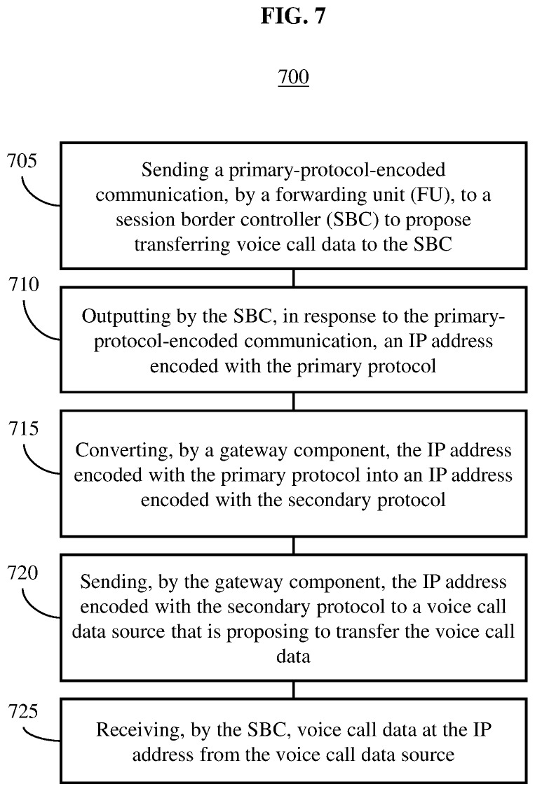

FIG. 7 shows a flowchart diagram of embodiments 700 for securing internet-based transfer of voice call data according to some embodiments of the present invention.

In operation 705, a forwarding unit (FU) may send a primary-protocol-encoded communication to a session border controller (SBC) to propose transferring voice call data to the SBC. Operation 705 may take place when an indication is received at the FU that a communication has been received at a gateway component from a voice call data source. The communication that has been received at a gateway component from a voice call data source may, for example, be encoded with a secondary or tertiary protocol. The FU may be communicatively coupled to the SBC and to the gateway component. The primary-protocol-encoded communication may comprise a request to establish a source-agnostic connection to the SBC, and/or may be referred to as a media forwarding request. The SBC may be configured to use communications encoded with the primary protocol. The gateway component may be configured to communicate with the voice call data source using at least the secondary protocol. The gateway component may also be configured to communicate with the voice call data source using one or more tertiary protocols. The primary protocol and the secondary protocol may be different protocols. The primary protocol may be a standard voice over IP (VOIP) protocol, such as Session Initiation Protocol (SIP). The forwarding unit (FU) may be a selective forwarding unit (SFU).

In operation 710, an IP address encoded with the primary protocol may be outputted by the SBC in response to the primary-protocol-encoded communication. The IP address may be indicative of a location configured to receive the voice call or telephony data. The location may be an IP address of or under the control of an SBC, such as 320 of FIG. 3 or 420 of FIG. 4. The IP address may be a number representing a location on a network, e.g., “44.225.4.163”, which may be encoded in a protocol, for example comprising many lines of text which includes the IP address, possibly alongside other information, for example, one line of an IP address encoded in a SIP protocol may read: “ . . . c=IN IP4 44.225.4.163.”

In operation 715, the IP address encoded with the primary protocol may be converted into an IP address encoded with the secondary protocol by a gateway component. The process of converting between primary and secondary protocols may depend on the specific protocols that are used. The conversion may be carried out using one or more scripts or computer programs. For example, a line including an IP address encoded in a SIP protocol may read: “ . . . c=IN IP4 44.225.4.163 . . . ”, whereas a corresponding line including an IP address in an Avaya protocol may read” . . . address: 44.225.4.163 . . . “Conversion may include converting other values that may be required according to a specific implementation, for example, where the call is given a call ID, this may be encoded in a SIP protocol as” . . . . X-Pbx-Call-ID: 4513 . . . “and may be encoded in an Avaya protocol as “ . . . callid: 4513 . . . ” How to convert information from one protocol into another (e.g., using a script or computer program) may be known in the art. Additional information for recording may be converted from primary to secondary protocols, such as which codec should be used, for example the G711 or G729 codecs.

In operation 720, the gateway component may send the IP address encoded with the secondary protocol to a voice call data source that is proposing to transfer the voice call data.

In operation 725, the SBC may receive voice call data at the IP address from the voice call data source.

In some embodiments, the received voice call data may be directed by the SBC to a recorder service.

In some embodiments, an indication of the communication (e.g., as received at a gateway component from a voice call data source) may be transmitted by the gateway component to the FU. The indication may be transmitted via a voice call data recording controller. The voice call data recording controller may instruct the FU to send the primary-protocol-encoded communication to the SBC requesting to establish the source-agnostic connection to the SBC.

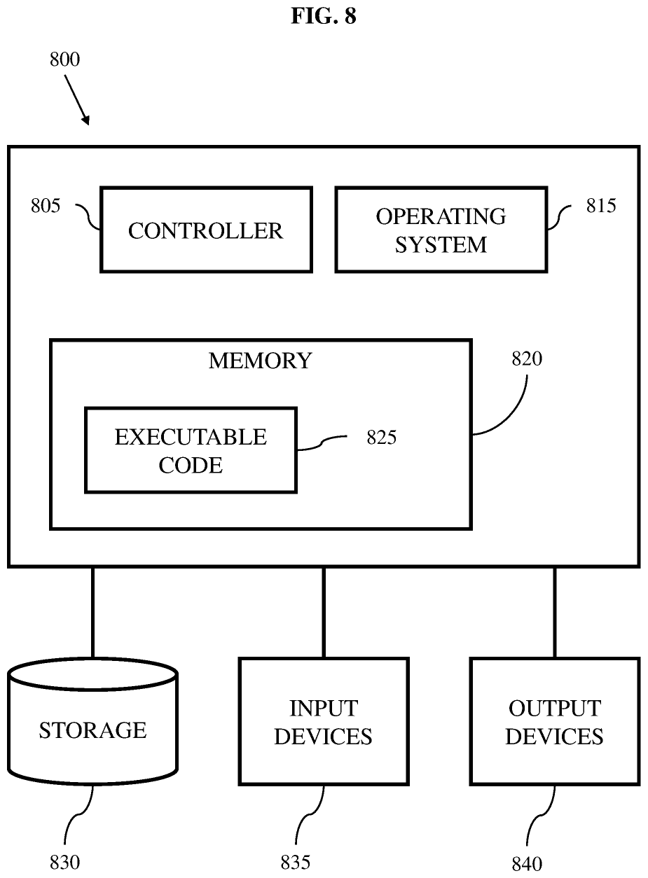

FIG. 8 shows a block diagram of an exemplary computing device which may be used with embodiments of the present invention. Computing device 800 may include a controller or computer processor 805 that may be, for example, a central processing unit processor (CPU), a chip or any suitable computing device, an operating system 815, a memory 820, a storage 830, input devices 835 and output devices 840 such as a computer display or monitor displaying for example a computer desktop system.

Operating system 815 may be or include code to perform tasks involving coordination, scheduling, arbitration, or managing operation of computing device 800, for example, scheduling execution of programs. Memory 820 may be or may include, for example, a Random Access Memory (RAM), a read only memory (ROM), a Flash memory, a volatile or non-volatile memory, or other suitable memory units or storage units. At least a portion of Memory 820 may include data storage housed online on the cloud. Memory 820 may be or may include a plurality of different memory units. Memory 820 may store, for example, instructions (e.g., code 825) to carry out methods as disclosed herein, for example, embodiments associated with FIGS. 1-7. Memory 820 may use a datastore, such as a database.

Executable code 825 may be any application, program, process, task, or script. Executable code 825 may be executed by controller 805, possibly under control of operating system 815. For example, executable code 825 may be, or may execute, one or more applications performing methods as disclosed herein, such as securing internet-based transfer of voice call data. In some embodiments, more than one computing device 800 or components of device 800 may be used. One or more processor(s) 805 may be configured to carry out embodiments of the present invention by, for example, executing software or code.

Storage 830 may be or may include, for example, a hard disk drive, a solid-state drive, a compact disk (CD) drive, a universal serial bus (USB) device or other suitable removable and/or fixed storage unit. Data described herein may be stored in a storage 830 and may be loaded from storage 830 into a memory 820 where it may be processed by controller 805. Storage 830 may include cloud storage.

Input devices 835 may be or may include a mouse, a keyboard, a touch screen or pad or any suitable input device or combination of devices. Output devices 840 may include one or more displays, speakers, virtual reality headsets, and/or any other suitable output devices or combination of output devices. Any applicable input/output (I/O) devices may be connected to computing device 800, for example, a wired or wireless network interface card (NIC), a modem, printer, a universal serial bus (USB) device or external hard drive may be included in input devices 835 and/or output devices 840.

Embodiments of the invention may include one or more article(s) (e.g., memory 820 or storage 830) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

Computing device 800 may additionally comprise a communication unit for communicating, transferring, transmitting, and/or receiving data to, from, or between another computing device (e.g., one similar to device 800).

Embodiments may improve third-party voice call recording technology by providing systems and methods that are capable of secure, protocol-agnostic, third-party (or contact center) recording of voice calls. Embodiments disclosed herein may leverage existing security devices, such as session border controllers (SBCs), which are configured to operate using a primary protocol, such that they may be used as security devices for contact centers configured to use secondary protocols.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system for securing internet-based transfer of voice call data, comprising:
a session border controller (SBC), configured to use communications encoded with a primary protocol;
a gateway component, configured to communicate with a voice call data source using a secondary protocol;
a connectivity component, configured to communicate with a voice call data source;
a forwarding unit (FU) communicatively coupled to the SBC and to the connectivity component;
wherein, when a communication is received at the connectivity component, from the voice call data source, to propose transferring voice call data to the SBC, the connectivity component is to transmit an indication to the FU and the FU is to send a primary-protocol-encoded communication to the SBC requesting to establish a source-agnostic connection to the SBC;
wherein the SBC is to, in response to the primary-protocol-encoded communication to the SBC, output an IP address encoded with the primary protocol, the IP address indicative of a location configured to receive the voice call data;
wherein the gateway component is to:
convert the IP address encoded with the primary protocol into an IP address encoded with the secondary protocol, and
send the IP address encoded with the secondary protocol to the voice call data source that is proposing to transfer the voice call data.

2. The system of claim 1, wherein the SBC is to:
receive voice call data at the IP address from the voice call data source.

3. The system of claim 2, wherein the SBC is to:
direct the voice call data to a recorder service.

4. The system of claim 1, wherein the primary protocol and the secondary protocol are different protocols.

5. The system of claim 4, wherein the primary protocol is a Session Initiation Protocol (SIP).

6. The system of claim 1, wherein the forwarding unit (FU) is a selective forwarding unit (SFU).

7. The system of claim 1, wherein, when the connectivity component is to transmit an indication of the communication to the FU, the indication is transmitted via a voice call data recording controller, and wherein the voice call data recording controller instructs the FU to send the primary-protocol-encoded communication to the SBC requesting to establish the source-agnostic connection to the SBC.

8. A method for securing internet-based transfer of voice call data, comprising:
sending a primary-protocol-encoded communication, by a forwarding unit (FU), to a session border controller (SBC), when an indication is received at the FU that a communication has been received at a connectivity component, from a voice call data source, to propose transferring voice call data to the SBC,
wherein the FU is communicatively coupled to the SBC and to the connectivity component, wherein the primary-protocol-encoded communication comprises a request to establish a source-agnostic connection to the SBC, wherein the SBC is configured to use communications encoded with the primary protocol and the connectivity component is configured to communicate with the voice call data source;
outputting by the SBC, in response to the primary-protocol-encoded communication an IP address encoded with the primary protocol,
wherein the IP address indicative of a location configured to receive the voice call data;
converting, by a gateway component, the IP address encoded with the primary protocol into an IP address encoded with the secondary protocol, wherein the gateway component is configured to communicate with the voice call data source using a secondary protocol; and
sending, by the gateway component, the IP address encoded with the secondary protocol to the voice call data source that is proposing to transfer the voice call data.

9. The method of claim 8, comprising:
receiving, by the SBC, voice call data at the IP address from the voice call data source.

10. The method of claim 9, comprising:
directing, by the SBC, the voice call data to a recorder service.

11. The method of claim 8, wherein the primary protocol and the secondary protocol are different protocols.

12. The method of claim 11, wherein the primary protocol is a Session Initiation Protocol (SIP).

13. The method of claim 8, wherein the forwarding unit (FU) is a selective forwarding unit (SFU).

14. The method of claim 8, comprising:
transmitting, by the connectivity component to the FU, an indication of the communication,
wherein the indication is transmitted via a voice call data recording controller; and
instructing, by the voice call data recording controller to the FU, to send the primary-protocol-encoded communication to the SBC requesting to establish the source-agnostic connection to the SBC.

15. A method for internet-based transfer of telephony data, comprising:
transmitting a communication encoded by a first protocol, by a forwarding unit (FU), to a server security component, upon an indication being received at the FU that a communication has been received at a server connection, from a telephony data source, to transfer telephony data to the server security component,
wherein the FU is in communication with the server security component and a server connection, wherein the communication encoded by a first protocol comprises a request to establish a source-agnostic connection to the server security component, wherein the server security component is configured to use communications encoded with the first protocol and the server connection is configured to communicate with the telephony data source;
outputting by the server security component an IP address encoded with the first protocol,
wherein the IP address is of a location to receive the telephony data;
converting, by a gateway component, the IP address encoded with the first protocol into an IP address encoded with a secondary protocol; and
sending, by the gateway component, the IP address encoded with the secondary protocol to the telephony data source.

16. The method of claim 15, comprising:
receiving, by the server security component, telephony data at the IP address from the telephony data source.

17. The method of claim 16, comprising:
directing, by the server security component, the telephony data to a recorder service.

18. The method of claim 15, wherein the primary protocol and the secondary protocol are different protocols.

19. The method of claim 18, wherein the primary protocol is a Session Initiation Protocol (SIP).

20. The method of claim 8, comprising:
transmitting, by the server connection to the FU, an indication of the communication,
wherein the indication is transmitted via a telephony data recording controller; and
instructing, by the telephony data recording controller to the FU, to send the primary-protocol-encoded communication to the server security component requesting to establish the source-agnostic connection to the server security component.
